(19) United States
(12) Patent Application Publication
(10) Pub. No.: US 2007/0162484 A1
(43) Pub. Date: Jul. 12, 2007

(54) Document role determination

(76) Inventors: Gerd Martin Ritter, Heidelberg (DE); Andre Wachholz-Prill, Bellheim (DE); Volkmar Stegmann, Altlussheim (DE)

Correspondence Address: SCHWEGMAN, LUNDBERG, WOESSNER & KLUTH, P.A., P.O. BOX 2938, MINNEAPOLIS, MN, 55402, US

(21) Appl. No.: 11/322,571

(22) Filed: Dec. 30, 2005

(51) Int. Cl. G06F 7/00

(52) U.S. Cl. 707/102

(57) ABSTRACT

The present subject matter, in various embodiments, provides systems, software, and methods to automatically determine roles to include, and not include, in documents. Some embodiments further include populating the roles in documents. Determining roles to include and not include, in some embodiments, includes branching decisions, the result of which can be to include one of multiple roles, or not including a role.

### BACKGROUND

Business documents such as sales orders, service orders, delivery and shipping documents, correspondence, appointments, and the like generally include contact, role, or partner fields. Such fields identify people or organizations in roles relevant to the purpose of the particular business document. These roles for a sale order can include buyer, payer, bill-to, sales organization or person, and a contact. For a service order, these roles can include buyer, payer, field service person or team, and the service recipient. For a business activity, such as a meeting, these roles can include the meeting organizer, a sales representative, a contact person, a client, or other attendee or interested party.

In a business setting, computer systems are used to generate these business documents. Some such computer systems include contact management software to generate these documents. Some such computer systems can determine role information for a document based on a small set of data such as client or buyer name. For example, when a client name is entered into the system for a sales order, the role information for a sales order can be automatically populated. However, such systems suffer from a lack of flexibility and from rigid role requirements that cannot be adapted or omitted. Such systems further suffer because they only provide role determination processes that are encapsulated to individual documents. Thus, process sharing between documents is not possible. Therefore, the abilities of such systems can be limiting in today's dynamic business environment.

### BRIEF DESCRIPTION OF THE DRAWINGS

FIG. 1 is a schematic block diagram of a system according to an example embodiment.

FIG. 2 is a schematic block diagram of a system according to an example embodiment.

FIG. 3 is a block diagram of a method according to an example embodiment.

FIG. 4 is a block diagram of a process according to an example embodiment.

### SUMMARY

The present subject matter, in various embodiments, provides systems, software, and methods to automatically determine roles to include, and not include, in documents. Some embodiments further include populating the roles in documents. Determining roles to include and not include, in some embodiments, includes branching decisions, the result of which can be to include one of multiple roles, or not including a role.

### DETAILED DESCRIPTION

In the following detailed description, reference is made to the accompanying drawings that form a part hereof, and in which is shown by way of illustration specific embodiments in which the present subject matter may be practiced. These embodiments are described in sufficient detail to enable those skilled in the art to practice them, and it is to be understood that other embodiments may be utilized and that structural, logical, and electrical changes may be made without departing from the scope of the present subject matter. Such embodiments of the present subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limiting sense, and the scope of the present subject matter is defined by the appended claims.

The functions or algorithms described herein are implemented in hardware, software or a combination of software and hardware in one embodiment. The software comprises computer executable instructions stored on computer readable media such as memory or other type of storage devices. The term “computer readable media” is also used to represent carrier waves on which the software is transmitted. Further, such functions correspond to modules, which are software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

Various embodiments of the present subject matter allow document role determination process sharing between document types in systems and methods that generate documents of various documents types. This provides the ability to define a role determination process for business partners that can be shared between document types. For example, a bill-to role determination process for a certain partner is defined in a system. That process can be shared between document types, such as invoices, shipping documents, quotes, and other document types having a bill-to roll to be populated with data. Some embodiments include role determination process that are not only shared between document types, but also between partners. For example, a process to determine contact role data of an entity defining the process can be shared across several document types for many partners.

Some embodiments also allow role determination processes to include branching decisions. For example, a given partner has a domestic division and an international division. Although a document to be generated for the given partner may need ship-to role data, the ship-to role data for the domestic division is different that the ship-to role data for the international division. Thus, a role determination process for the given partner includes at least one branching decision to determine the ship-to role data for the document to be generated based on information such as which given partner division caused the need for the document to be generated.

Further embodiments allow role determination processes to exclude a role from the document to be generated. For example, for a document to be generated, the document type can include customer service roles such as “Customer Service Representative,” “In-House Repair Technician,” and “Field-Service Repair Technician.” When populating role data to the document to be generated, the role determination process can take into account information such as partner location. The role determination process, in such an embodiment, will determine the proper “Field-Service Repair Technician.” If the process finds that there is not a “Field-Service Repair Technician” assigned to the partner's geographic area, the process includes a process stop point to exclude the “Field-Service Repair Technician” role from the document to be generated.

Document type, as used herein, can include virtually any document type. Some document types can be physically printed documents, while other document types exist only within a computer, computing system, database, or the like. Example document types include appointments that are electronically stored, invoices that are stored an can be printed or communicated electronically, shipping documents, letters, notices, quotes, service requests, and virtually any document type that might be generated by a person or entity utilizing the subject matter herein.

These embodiments, and others described below, illustrate the flexibility of the present subject matter. These embodiments also illustrate the increased efficiency that become available through the sharing of role determination processes across document types and even across partners. Thus, the present subject matter better meets the needs in today's dynamic business environment.

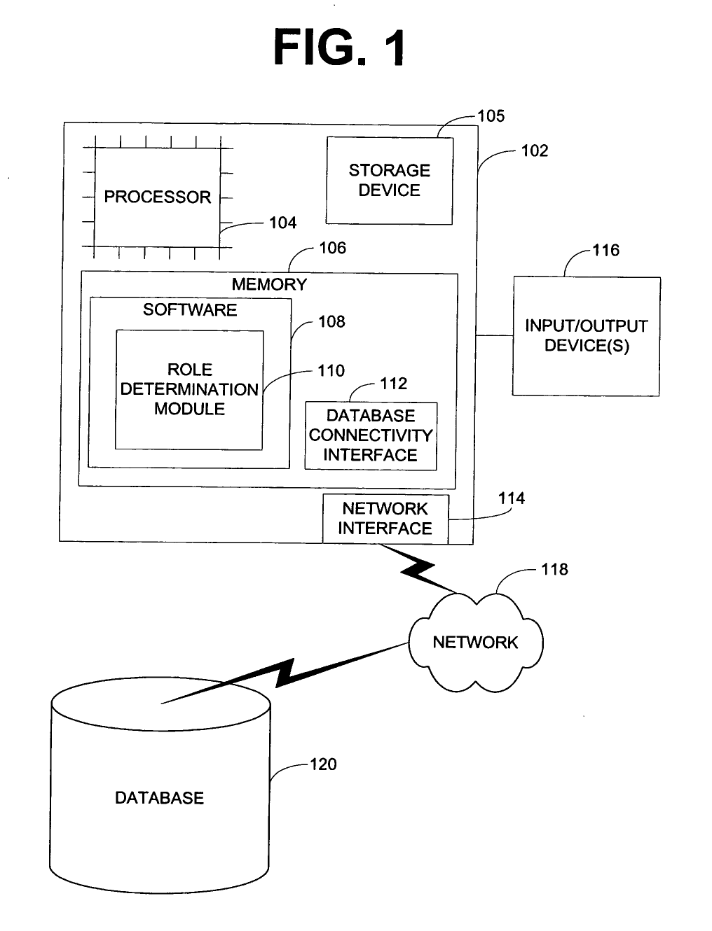

FIG. 1 is a schematic block diagram of a system 100 according to an example embodiment. The system 100 includes a computer 102 operatively coupled to a database 120 via a network 118.

The computer 102 includes an operating system that controls computer 102 operation. The computer 102 further includes a processor 104, memory 106, removable storage, and non-removable storage, such as storage device 105. The memory 106 can include volatile memory and non-volatile memory. The computer 102 can include—or have access to a computing environment that includes—a variety of computer-readable media, such as volatile memory and non-volatile memory, removable storage and non-removable storage, and databases, such as database 120. The memory 106 and storage device 105 can include random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices including hard drives, or any other medium capable of storing machine-readable instructions and data. The computer 102 can also include or have access to a computing environment that includes input and output devices 116, and communication connections, such as network interface 114. The computer 102 can operate in a networked environment using the network interface 114 to connect to one or more remote computers, such as the database 120 and other network resources. The network 118 can include one or more of a Local Area Network (LAN), a Wide Area Network (WAN), Internet, or other networks via wired or wireless connections.

Machine-readable instructions, such as software 108, stored on a machine-readable medium, such as the memory 106 or storage device 105, are executable by the processor 104. The term “machine-readable medium” is also used to represent carrier waves on which the software 108 is transmitted. For example, a computer program capable of providing a generic technique to perform access control check for data access and/or for doing an operation on one of the servers in a component object model (COM) based system according to the teachings of the present invention may be included on a CD-ROM and loaded from the CD-ROM to the memory 106 or storage device 105. In some embodiments, the machine-readable instructions allow the computer 102 to provide generic access controls in a COM, TCP/IP, Server Message Block (“SMB”), or other protocol based, or protocol-hybrid, network systems having multiple users and servers.

The database connectivity interface 112 provides database connection functionality to processes, modules, programs, and other software executing on the computer 102. In some embodiments, the database is a database on the network 118, such as database 120. In other embodiments, the database is local to the computer 102 and stored in the storage device 105. The database connectivity interface 112, in some embodiments, is an Object Database Connectivity (“ODBC”) interface. In other embodiments, the database connectivity interface 112 is a Java Database Connectivity (“JDBC”) interface or other suitable database connectivity interface 112 as needed in the particular embodiment.

In some embodiments, the software 108 in the memory 106 includes a role determination module 110. In some such embodiments, the role determination module 110 provides user interfaces to computer 102 users on an input/output device 116, such as a monitor. The user interfaces receive input via an input/output device 116, such as a keyboard and mouse, representative of a document type to create and a subset of document data. In some embodiments, the document type is a “quote” document type and the subset of document data is a business partner or client identifier, such as a name. In some such embodiments, the role determination module 110 then determines needed document roles as a function of the received document type representation and the subset of document data. In some embodiments, determining needed roles includes following one or more defined processes stored within the system 100, such as within the database 120. The one or more defined processes are operative to populate only the needed document roles to the document if not already populated by the subset of document data and retrieve role information from a storage location, such as the database 120 or the storage device 105. Retrieving the role information can include retrieving role information as a function of the subset of document information the populated document roles. In some such embodiments, the role information can be retrieved using all or a portion of the subset of document data as one or more database 120 retrieval arguments. The retrieved role information is then populated into role fields of the document. In some embodiments, the retrieved role information includes only a subset of possible roles to include a document to be generated.

In some embodiments, the role determination module 110 is further operative to query the storage location including document role data based at least in part on the document type representation and the subset of document data. In response to the query, the role determination module can receive document role data identifying the role fields to be included in the document. In some embodiments, the role determination module, in response to the query, also receives data to populate the identified roles fields with role data. In some embodiments, the role data includes contact information, shipping addresses, and other information.

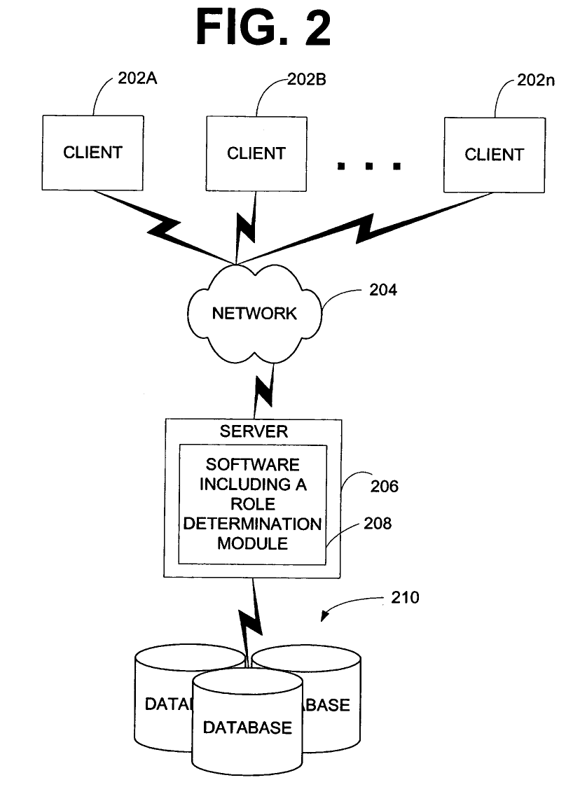

FIG. 2 is a schematic block diagram of a system 200 according to an example embodiment. The system 200 includes a plurality of clients 202A, 202B, and 202n, where “n” is a total number of the plurality of clients. The system 200 further includes a server 206 operatively interconnected to the clients 202A, 202B, 202n via a network 204. The server is further operatively connected to one or more databases 210 via a dedicated link, such as a storage area network or via a bus internal to the server. In such embodiments, the storage area network, in some embodiments is also interconnected to the network.

The server 206, in the illustrated example system 200, has software including a role determination module 208. The software including the role determination module 208 is operative to receive data from the clients 202A, 202B, 202n relating to documents to be generated and serve data to the client 202A, 202B, 202n with data and user interfaces to facilitate document creation and role determination and population for created documents. In some embodiments, the clients 202A, 202B, 202n interact with the server 206 software including the role determination module 208 over the network 204 through a web browser on the clients 202A, 202B, 202n.

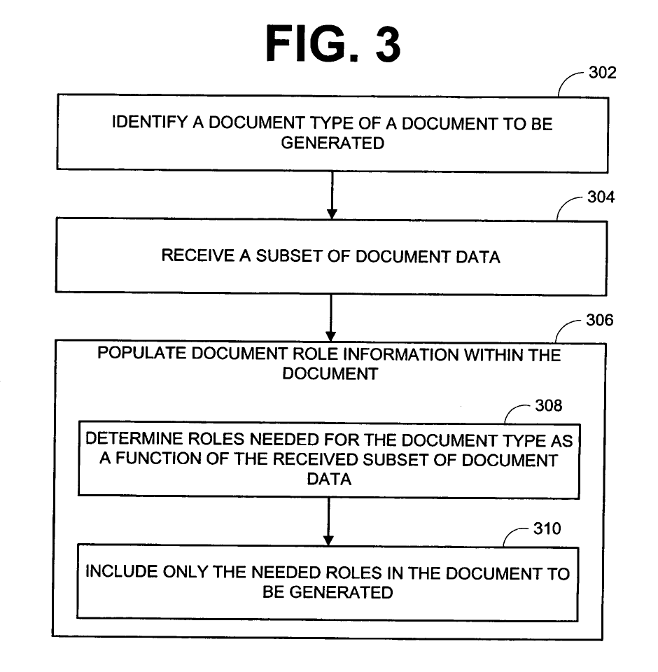

FIG. 3 is a block diagram of a method 300 according to an example embodiment. The example method 300 includes identifying a document type of a document to be generated 302, receiving a subset of document data 304, and populating document role information within the document 306. In some embodiments, populating document role information within the document 306 includes determining roles needed for the document type as a function of the received subset of document data 308 and including only the needed roles in the document 310.

In some embodiments of the method 300, the subset of document data includes data representative of a client, such as a business partner. The data representative of the client can include a client name, a client contact, a database value, such as a database table key, or other data that can be used to identify a client. In some embodiments, a universe of client identifiers is provided from which a client identifier can be selected.

In some embodiments, determining roles needed for the document type as a function of the received subset of document data 308 includes querying a database including document role data and receiving document role data from the database. In some such embodiments, the query of the database is based on arguments including the document type and the subset of document data. Further, receiving document role data from the database can include receiving role data identifying the roles to be included in the document. In such embodiments, potential document type roles not included with the received data are not to be included in the document.

In some embodiments, determining roles needed for the document type 308 includes performing a process that includes one or more branching decisions. In such processes, the process can make role determinations based on the identified document type to be generated 302, such as an invoice, and the received subset of document data 304, such as the client identifier. An example process queries a database including document role data and can determine for the client identifier, the roles for an invoice only include a general client contact role, a client accounts payable role, a bill-to role, and an accounts receivable role of an entity that defined the process and is executing the method 300. Other embodiments, can include multiple branching decisions.

In some embodiments, determining roles needed for the document type 308 includes performing a process that includes a “stop” which causes one or more potential document type roles to be excluded from a document.

Processes can be defined by users and administrators to determine client role information across multiple documents. For example, a client X requests that copies of all documents be sent to a copy contact. A copy contact role for client X can be defined and associated specifically with the client to cause a copy of every document to be sent to the copy contact. At the same time, client X may not want copies of all documents to be sent to the copy contact except appointment confirmation documents. The client X copy contact role process then can include a branching decision to determine if the document to be generated is an appointment confirmation document. If so, the copy contact role will not be included in the document, otherwise the copy contact role will be included. The example process 400 provides a larger example of a role determination process.

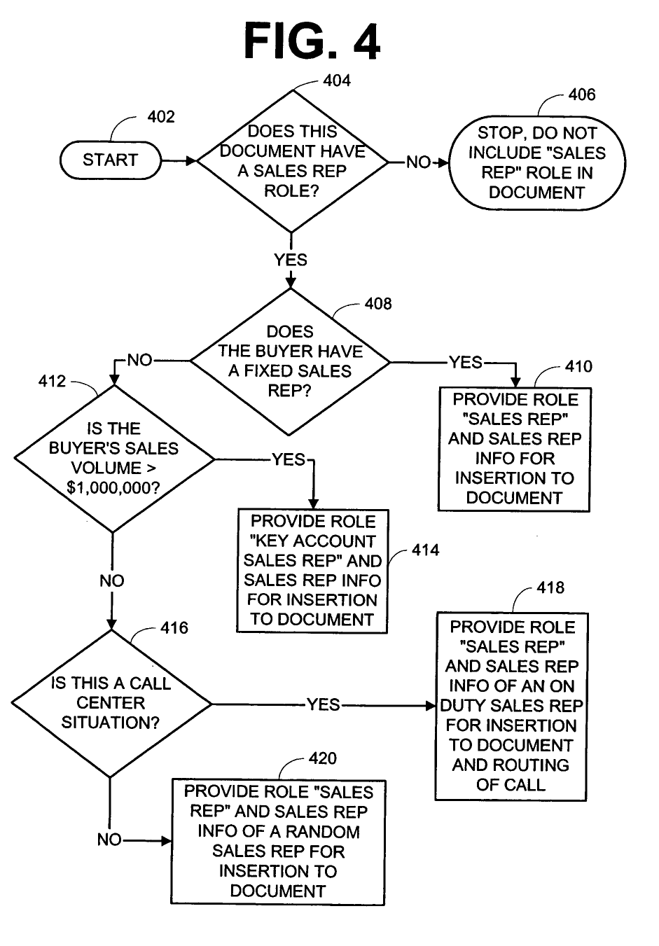

In some embodiments, the caller of a process, such as the process 400, is a user interface. The user interface, in such embodiments, after a document type to be generated and a client identifier is received, automatically calls one or more processes to determine roles to include in the document to be generated and obtain role information. The determined roles and role information are then populated in the user interface for the document to be generated. The document type and client identifier, in some user interface embodiments, can be selected from a list, such as from a drop down list box of the user interface. In other embodiments, the client identifier is typed into a user interface field or selected using another user interface tool. After the document has been generated in the user interface, the document, in various embodiments, can be saved, forwarded electronically, printed, or otherwise stored, generated, or forwarded. A further example of such a process is illustrated in FIG. 4

FIG. 4 is a block diagram of a process 400 according to an example embodiment. The illustrated process 400 is an example of a role determination process as described above with regard to the method 300 of FIG. 3 to determine roles to include in a document to be generated. The process 400 is also a process that can exist within the role determination module 110 of FIG. 1 and the role determination module 208 of FIG. 2.

The process 400 starts at 402. The input to this process 400 includes a document type to be generated and a client identifier. The process 400 first makes a branching decision at 404 to determine if the document type has a sales representative role. If not, the process 400 stops at 406 and a sales representative role is not included in the document. If the document type has a sale representative role, the process at 408 makes another branching decision to determine if the buyer, as identified by the client identifier, has a fixed sales representative.

If the buyer has a fixed sales representative, the process 400 at 410 provides, through one or more return values to the caller of the process 400, the role “Sales Representative” and sales representative information to insert into the document to be generated. If the buyer does not have a fixed sales representative, the process 400 at 412 makes another branching decision to determine if the buyer's sales volume is greater than $1,000,000. If the sales volume is greater, then the process 400 at 414 provides the role “Key Account Sales Representative” and sales representative information to insert into that role in the document to be generated.

If the buyer's sales volume is less than $1,000,000, the process 400 at 416 makes a branching decision to determine if the caller of the process 400 is in a call center situation, such as when the document type is a scheduled service telephone call from a call center sales representative.

If this is a call center situation, the process 400 at 418 provides the role “Sales Representative” and sales representative information to insert into the document to be generated of a sales representative that is on duty. In some embodiments, to identify a sales representative that is on duty can be a database lookup, or the calling of another process that identifies an on duty sales representative.

If this is not a call center situation, the process 400 at 420 provides the role “Sales Representative” and sales representative information of a randomly selected sales representative for insertion into the document to be generated.

In some embodiments where a process, such as the process 400, needs to make a branching decision based on data not already held by the process, the process obtains the data by retrieving the data from a data store, such as a database. For example, in the process 400 at 412, the process 400 requires the buyer's sales volume. In this instance, the process 400 can retrieve the needed data from a database. In other embodiments, the process can require such additional data be provided when calling the process.

The process 400 is provided as an example process that can be defined for use by a method, such as method 300 of FIG. 3, or in a system, such as system 100 of FIG. 1 or system 200 of FIG. 2. Other processes can be defined as needed based on document type needs and client preferences in specific embodiments.

It is emphasized that the Abstract is provided to comply with 37 C.F.R. §1.72(b) requiring an Abstract that will allow the reader to quickly ascertain the nature and gist of the technical disclosure. It is submitted with the understanding that it will not be used to interpret or limit the scope or meaning of the claims.

In the foregoing Detailed Description, various features are grouped together in a single embodiment to streamline the disclosure. This method of disclosure is not to be interpreted as reflecting an intention that the claimed embodiments of the present subject matter require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

It will be readily understood to those skilled in the art that various other changes in the details, material, and arrangements of the parts and method portions which have been described and illustrated in order to explain the nature of this invention may be made without departing from the principles and scope of the invention as expressed in the subjoined claims.

What is claimed is:

1. A method comprising:
identifying a document type of a document to be generated;
receiving a subset of document data; and
populating document role information within the document, wherein populating document role information includes:
determining roles needed for the document type as a function of the received subset of document data; and
including only the needed roles in the document to be generated.

2. The method of claim 1, wherein the subset of document data includes data representative of a client.

3. The method of claim 2, wherein the data representative of a client includes a client name.

4. The method of claim 1, wherein determining roles needed for the document type as a function of the received subset of document data includes:
querying a database including document role data, wherein the query is based on arguments including the document type and the subset of document data; and
receiving document role data from the database, wherein the role data identifies the roles to be included in the document.

5. The method of claim 1, wherein receiving document role information from the database includes receiving the document role information from a data buffer on an application server.

6. The method of claim 1, wherein the document type to be generated is an invoice.

7. The method of claim 1, wherein determining roles needed for the document type as a function of the received subset of document data includes one or more branching decisions.

8. The method of claim 7, wherein at least one branching decision is made based on data retrieved from a database including document role data.

9. A machine-readable medium, with instructions thereon which when processed, result in a machine:
identifying a document type of a document to be generated;
receiving a subset of document data; and
populating document role information in the document, wherein populating document role information includes:
determining roles needed for the document type as a function of the received subset of document data; and
including only the needed roles in the document to be generated.

10. The machine-readable medium of claim 9, wherein the subset of document data includes data representative of a client.

11. The machine-readable medium of claim 10, wherein the data representative of a client includes a client name.

12. The machine-readable medium of claim 9, wherein determining roles needed for the document type as a function of the received subset of document data includes:
querying a database including document role data, wherein the query is based on arguments including the document type and the subset of document data; and
receiving document role data from the database, wherein the role data identifies the roles to be included in the document.

13. The machine-readable medium of claim 9, wherein receiving document role information from the database includes receiving the document role information from an application server data buffer.

14. The machine-readable medium of claim 9, wherein the document type to be generated is an invoice.

15. The machine-readable medium of claim 9, wherein determining roles needed for the document type as a function of the received subset of document data includes one or more branching decisions.

16. The machine-readable medium of claim 15, wherein at least one branching decision is made based on data retrieved from a database including document role data.

17. A system comprising:
a role determination module, wherein the role determination module is operative to:
receive a document type representation and a subset of document data for a document, and
determine needed document roles as a function of the received document type representation and the subset of document data; and
a document role populating module, wherein the document role populating module is operative to:
populate only the needed document roles to the document if not already populated,
retrieve role information from a storage location including role information as a function of the subset of document information the populated document roles, and
populate the retrieved role information into role fields of the document.

18. The system of claim 17, wherein the subset of document data includes data representative of a client.

19. The system of claim 17, wherein the role determination module is further operative to:
query the storage location including document role data, wherein the query is based at least in part on the document type representation and the subset of document data; and
receive document role data from the storage location, wherein the role data identifies the roles to be included in the document.

20. The system of claim 16, wherein the storage location is a datastore on an application server.
